(19) United States
(12) Patent Application Publication
(10) Pub. No.: US 2012/0158536 A1
(43) Pub. Date: Jun. 21, 2012

(54) IDENTIFYING CONTENT PURCHASING OPTIONS BASED ON USER PREFERENCES

(75) Inventor: Max Stephen Gratton, Lakewood, CO (US)

(73) Assignee: Dish Network L.L.C., Englewood, CO (US)

(21) Appl. No.: 12/970,463

(22) Filed: Dec. 16, 2010

(51) Int. Cl. G06Q 30/00

(52) U.S. Cl. 705/26.7

(57) ABSTRACT

Identifying content purchasing options based on user preferences is described. In one aspect, a system receives user content preferences. Multiple content packages associated with a content provider are identified such that the content packages include at least a portion of the user content preferences. The system identifies any user content preferences missing from each of the multiple content packages. Based on the identified content packages and the user content preferences, a listing of content purchasing options is generated that is appropriate for the user. The listing of content purchasing options also includes any user content preferences missing from each of the multiple content packages.

### BACKGROUND

When shopping for television programming or other content, users often consider content packages available from one or more content providers. For example, when shopping for content from a satellite or cable-based content provider, users typically compare different packages that offer different content options, such as different television channels. These packages have different prices depending on the content included in the package.

### SUMMARY

The described systems and methods relate to identifying content purchasing options based on user preferences. In a specific implementation, user content preferences are received. Multiple content packages associated with a content provider are identified that include at least a portion of the user content preferences. Any user content preferences missing from each of the multiple content packages also are identified. A listing is generated that includes content purchasing options appropriate for the user based on the identified content packages and the user content preferences. The listing also includes any user content preferences missing from each of the multiple content packages.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In the Figures, the left-most digit of a component reference number identifies the particular Figure in which the component first appears.

FIG. 1 shows an exemplary environment capable of implementing the systems and methods described herein.

FIG. 2 shows an exemplary procedure for identifying content purchasing options based on a user's content preferences, according to one embodiment.

FIGS. 3A and 3B show an exemplary procedure for identifying content packages and per-episode content that satisfies a user's content preferences, according to one embodiment.

FIG. 4 shows an exemplary procedure for identifying content purchasing options by a content analysis system, according to one embodiment.

FIG. 5A shows an exemplary display that allows a user to select preferred channels available from one or more content providers, according to one embodiment.

FIG. 5B shows an exemplary display that identifies content packages including at least a portion of the user's preferred channels, according to one embodiment.

FIG. 6A shows an exemplary display that allows a user to select preferred programs available from one or more content providers, according to one embodiment.

FIG. 6B shows an exemplary display that identifies per-episode content as well as content packages including at least a portion of the user's preferred programs, according to one embodiment.

FIG. 7 is a block diagram showing an exemplary computing device, according to one embodiment.

### DETAILED DESCRIPTION

### Overview

Existing systems that allow a consumer to review television programming or other content packages for subscription or purchase typically display package comparisons based solely on package price and content. However, most users are interested in watching particular programs, and do not necessarily know which channels carry their favorite programs. Using today's digital video recording (DVR) technology and electronic program guides (EPGs), many users watch and record television programs without knowing the channel associated with the program. Without knowing the channels that carry their favorite shows, comparing content packages based on channels is not helpful to users when selecting a package. This approach to selecting a content package is frustrating and may cause a user to select a package that does not allow them to watch all of their favorite programs. Additionally, many users may select a more expensive package when a lesser package provides all of their favorite programs.

The systems and methods described herein relate to identifying content purchasing options based on user preferences. The user defines their preferences based on specific content (e.g., television programs), content channels, sports teams, genre of content, and/or the like. After receiving user content preferences, the systems and methods identify content purchasing options that satisfy at least a portion of the user content preferences. The user is presented with purchasing options that include content packages and/or per-episode content. For example, a particular content package may contain most of the user's preferred content, while the preferred content missing from the package is offered on a per-episode (or per-season) basis. The user is also presented with more expensive content packages that may contain all of the user's preferred content. The described systems and methods for identifying content purchasing options allow the user to make an informed choice, based on their own content preferences, when purchasing content from one or more content providers.

Although particular examples discussed herein refer to television programs and television content, alternate embodiments may include any type of content intended for any type of device, including any type of display device. As used herein, “content” refers to any audio or audio/video data such as an entertainment program, a live event, a movie, or any other information presented to a user. As used herein, a “content purchasing option” includes a content package available from a single content provider, multiple combined content packages from one or more content providers, a combination of a content package and per-episode content, and any other arrangement of content episodes or content groupings.

Particular examples discussed herein refer to “per-episode content”. As used herein, “per-episode content” refers to content that allows purchasing of each episode or each instance of the program individually. For example, a specific television program may have twenty episodes in a particular season (or a particular series). In this example, the television program can be purchased as part of a larger package that includes all twenty episodes of the program. Alternatively, a user may choose to purchase one or more individual episodes of the program. In the embodiments described herein, purchasing “per-episode content” includes purchasing a single episode of a program or purchasing multiple episodes of a program. Purchasing “per-episode content” also includes purchasing an entire season (e.g., all twenty episodes) or multiple seasons of a program. A season may also be referred to as a “series” or “collection” of episodes.

### An Exemplary System for Identifying Content Purchasing Options

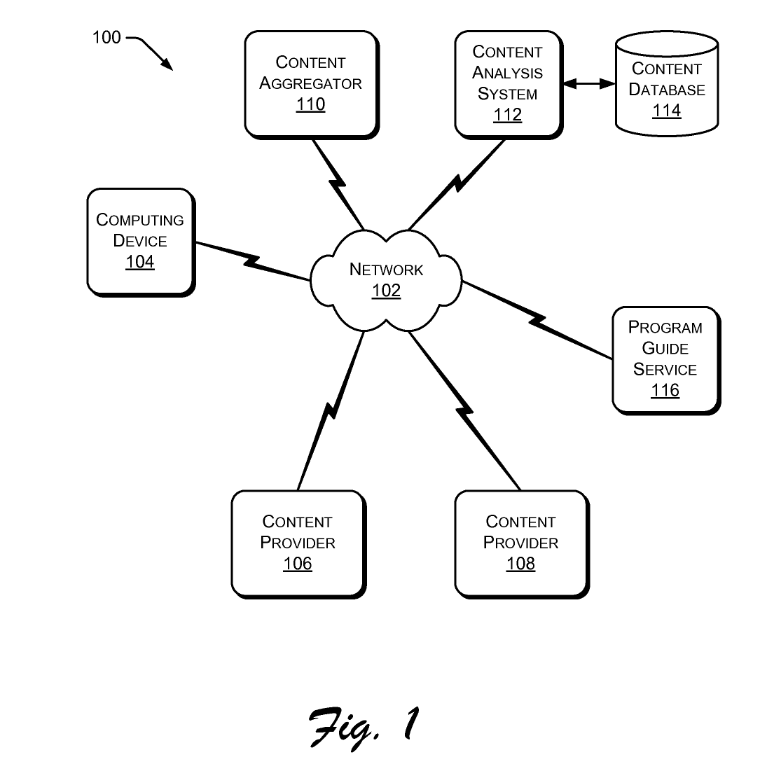

FIG. 1 shows an exemplary environment 100 capable of implementing the systems and methods described herein. A data communication network 102 allows multiple devices to communicate with one another. These multiple devices include a computing device 104 and two content providers 106 and 108. Computing device 104 includes a desktop computer, a laptop computer, a tablet computing device, a set top box, a game console, a mobile computing device (e.g., a smart phone), or any other device capable of communicating with one or more of the systems and services discussed herein. Content providers 106 and 108 represent any of a number of services that provide content, such as television content, to multiple end users (also referred to as “subscribers”). Content providers 106 and 108 may utilize any content distribution mechanism to distribute any type of content. Example content distribution mechanisms include satellite distribution systems, cable television distribution systems, wireless distribution systems, and Internet-based distribution systems.

In a particular embodiment, a user of computing device 104 accesses content provider 106 or 108 via data communication network 102 through a Web site associated with the content provider. As discussed in greater detail below, the content provider Web site includes information about the content and services available from the content provider to a subscriber. Data communication network 102 may use any network protocol and may include any network topology, including both wired and wireless communication systems. In a particular embodiment, data communication network 102 is the Internet.

A content aggregator 110 is also coupled to data communication network 102. As discussed herein, content aggregator 110 aggregates content from multiple content providers and other content sources to provide desired content packages to a user. A content analysis system 112 is coupled to data communication network 102 and further coupled to a content database 114. Content analysis system 112 identifies various content purchasing options based on user preferences provided to the content analysis system. As discussed herein, content analysis system 112 may access data contained in database 114 or access other data services to identify content purchasing options. In a particular embodiment, content analysis system 112 accesses data through a program guide service 116 when identifying content purchasing options. Program guide service 116 provides various television program content and schedule information to various systems. Example program guide services are available from Tribune Media Services and TV Guide Networks.

In a particular embodiment, content database 114 includes information regarding television programs, television channels, and other content-related data. Additionally, content database 114 contains listings (or other data structures) of television programs that are distributed via particular television channels. Content database 114 also includes pricing information for various content packages, as well as single episodes of a television program or other content. Although content analysis system 112 and content database 114 are shown in FIG. 1 as being coupled to data communication network 102, in alternate embodiments this system and database is coupled directly to content provider 106 or 108, or coupled directly to content aggregator 110. Additionally, content analysis system 112 and content database 114 may be incorporated into content provider 106 or 108, or incorporated into content aggregator 110.

Although FIG. 1 illustrates specific components and systems coupled to data communication network 102, particular environments may include any number of components and systems coupled together via one or more data communication networks.

### An Exemplary Procedure for Identifying Content Purchasing Options

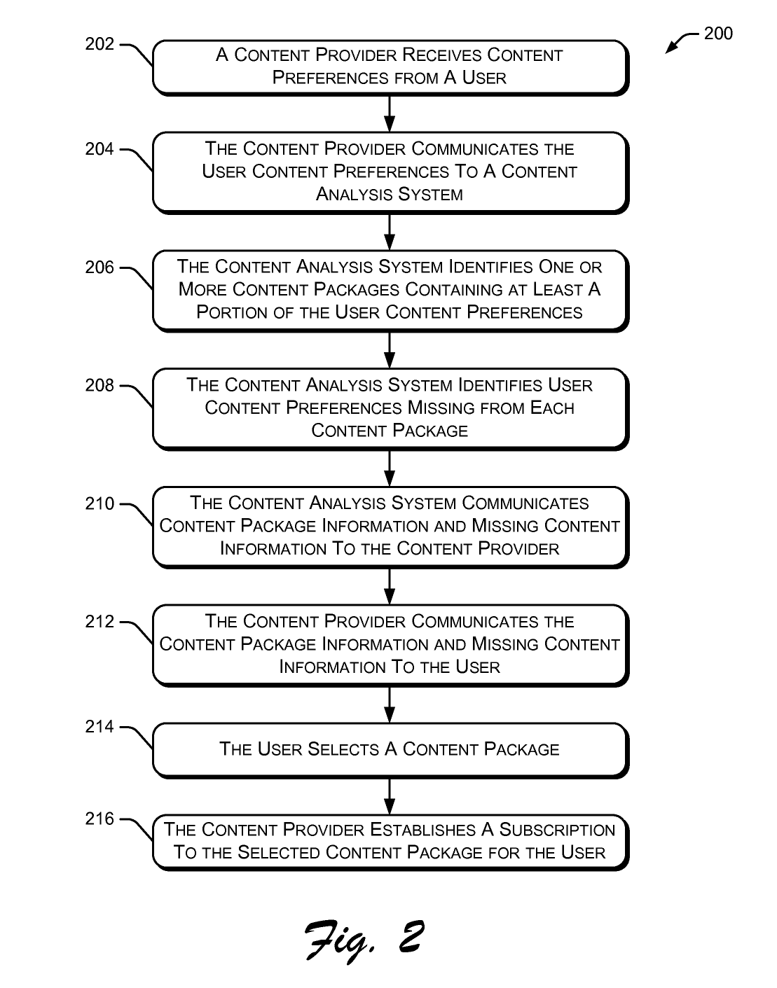

FIG. 2 shows an exemplary procedure 200 for identifying content purchasing options based on a user's content preferences, according to one embodiment. Initially, a content provider receives content preferences from a user (block 202). The content preferences may include the user's favorite programs, favorite channels, preferred genres of content, favorite sporting events, favorite sports teams, and the like. As discussed below, these content preferences can be provided by the user through a Web site associated with a content provider, a content aggregator, or other service/system. In the example of FIG. 2, the content provider communicates the user content preferences to a content analysis system (block 204). In one embodiment, the content analysis system is associated with a particular content provider. For example, the content analysis system analyzes content purchasing options associated with a single content provider. In other embodiments, the content analysis system is associated with multiple content providers. For example, the content analysis system analyzes content purchasing options associated with two or more different content providers.

Based on the user content preferences, the content analysis system identifies one or more content packages containing at least a portion of the user content preferences (block 206). A content package is a collection of content (e.g., a collection of television channels or television programs) bundled together as a single item available for purchase. The procedure continues as the content analysis system identifies user content preferences missing from each content package (block 208). For example, a user may identify ten favorite programs in the user content preferences. A particular content package may contain the channels that carry eight of the user's favorite programs, but the content package does not contain the remaining two of the user's favorite programs. In this example, the content package is “missing” two programs identified in the user content preferences.

Next, the content analysis system communicates content package information and missing content information to a content provider (block 210). Content package information includes the content included in the package, the cost of the package, and so forth. The missing content information includes the content in the user content preferences that is not included in the content package. The content provider communicates the content package information and the missing content information to the user (block 212). For example, the content package information and the missing content information can be displayed to the user via the content provider's Web site, as discussed herein. If the content analysis system identified multiple content packages, the content package information and missing content information for each package is displayed simultaneously in a tabular format. A user then selects a content package based on the information presented regarding the content package, missing content, and price (block 214). Finally, the content provider establishes a subscription to the selected content package for the user (block 216). Once the subscription is established, the user can begin receiving content from the content provider.

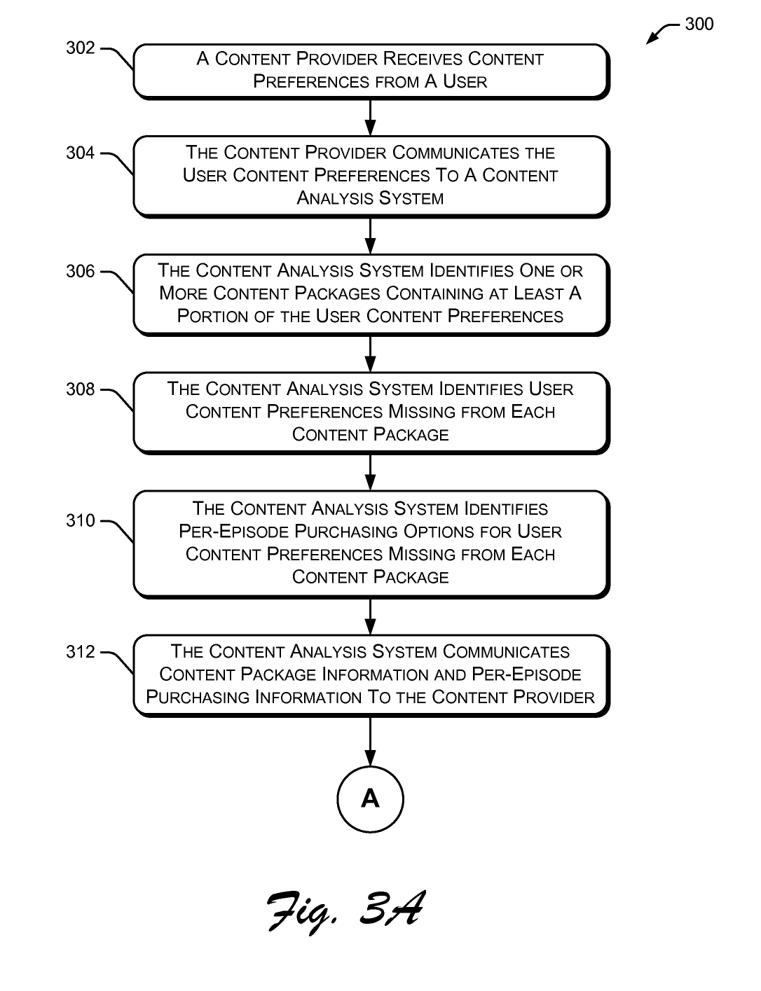

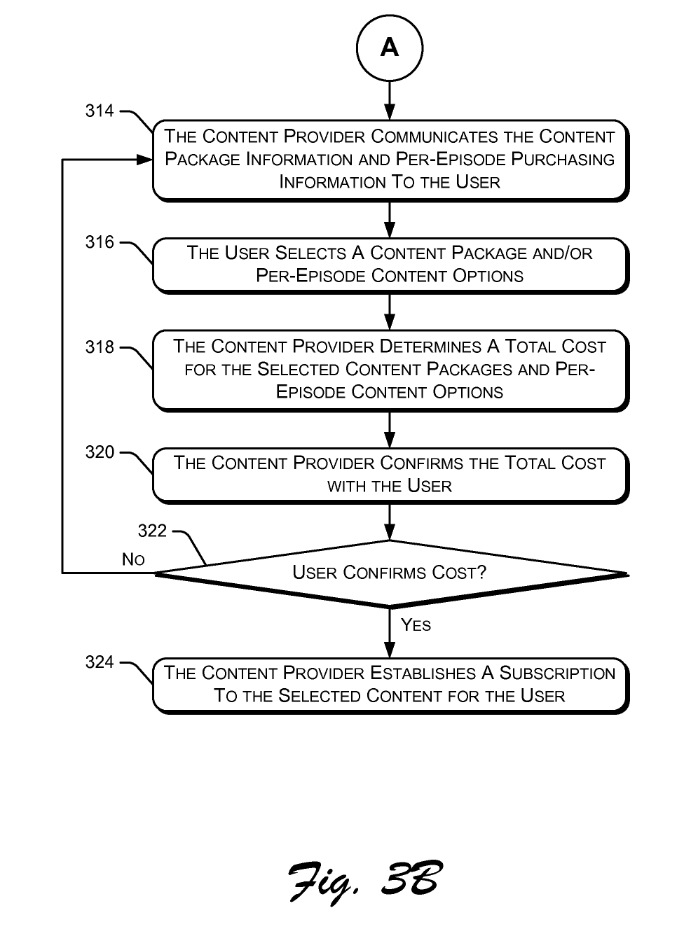

FIGS. 3A and 3B show an exemplary procedure 300 for identifying content packages and per-episode content that satisfies a user's content preferences, according to one embodiment. Procedure 300 is similar to the procedure shown in FIG. 2, but it includes options for per-episode content in addition to content packages (discussed in FIG. 2). Initially, a content provider receives content preferences from a user (block 302) and communicates the user content preferences to a content analysis system (block 304). The content analysis system identifies one or more content packages containing at least a portion of the user content preferences (block 306).

The content analysis system then identifies user content preferences that are missing from each of the identified content packages (block 308). The content analysis system further identifies per-episode purchasing options for user content preferences missing from each content package (block 310). A per-episode purchasing option is associated with content that can be purchased on a per-episode, per-series, or per-season basis. Per-episode purchasing options allow a user to purchase specific content on an episode-by-episode basis, rather than having to purchase an entire channel or an entire content package to gain access to one program. By identifying per-episode purchasing options, the user is presented with various content packages as well as combinations of content packages and per-episode content options that satisfy all of the user's content preferences.

The procedure continues as the content analysis system communicates the content package information and the per-episode content purchasing information to the content provider (block 312). The content provider then communicates the content package information and the per-episode content purchasing information to the user (block 314). As discussed above with respect to FIG. 2, multiple content packages as well as per-episode content purchasing options can be displayed simultaneously in a tabular format.

After reviewing the content packages and per-episode content purchasing options, the user selects a specific package or a combination of a content package and per-episode content (block 316). The content provider determines a total cost for the selected content packages and per-episode content options (block 318). The content provider then confirms the total cost with the user (block 320). If the user confirms the total cost at block 322, the procedure continues as the content provider establishes a subscription to the selected content for the user (block 324). If the user does not confirm the total cost at block 322, the procedure returns to block 314, which communicates content package information and per-episode content purchasing information to the user.

FIG. 4 shows an exemplary procedure 400 for identifying content purchasing options by a content analysis system, according to one embodiment. In a particular implementation, procedure 400 is performed by content analysis system 112 shown in FIG. 1. Initially, the content analysis system identifies a user's content preferences (block 402). As discussed herein, these content preferences may include programs, channels, sports teams, events, content genre, and the like. The content analysis system determines channels associated with programs in the user's content preferences using a content database (block 404). Since many content packages are defined by the channels in the package, the content analysis system identifies channels associated with the user's preferred programs. In a particular implementation, this information is obtained from content database 114 shown in FIG. 1. For example, content database 114 may include a table that associates channels with content packages and another table that associates programs with particular channels.

Procedure 400 continues as the content analysis system identifies channels associated with the sports teams, events, and other content identified in the user's preferences (block 406). As discussed above with respect to specific programs, identification of the channels associated with sports teams, events, and the like is performed using a content database. After the content analysis system has identified the channels associated with the user's content preferences, it identifies content packages that contain at least a portion of those channels associated with the user's content preferences (block 408). For each of the identified content packages, the content analysis system identifies content in the user's content preferences that is missing from the content package (block 410). Knowledge of this missing content is important in helping a user choose a particular content package. Finally, the content analysis system determines whether the missing content is available on a per-episode basis (block 412). In a particular embodiment, the content database contains information regarding availability and pricing of content on a per-episode basis. In other embodiments, this per-episode information is retrieved from a content provider or other content-related service.

As discussed above, the content analysis system communicates the content package information and the missing content information to a content provider or other requesting device for display to the user who provided their content preferences.

In one embodiment, procedure 400 obtains content package information from a single content provider. In this embodiment, the user typically is visiting a content provider's Web site and the content provider is assisting the user in selecting the best content package available from that particular content provider. Thus, although FIG. 1 shows two content providers 106 and 108, in one embodiment there is one content provider; in another embodiment there are more than two content providers.

In other embodiments, procedure 400 obtains content package information from multiple content providers. In this embodiment, the user typically is visiting a Web site associated with a service that aggregates product and service offerings from multiple content providers. When obtaining content package information (and per-episode content information) associated with multiple content providers, the content analysis system may access multiple content databases and/or multiple services that provide content-related information. In this embodiment, the user can enter their content preferences once and receive appropriate content package information from multiple content providers. This arrangement allows the user to select the content package that best meets their content preferences for the best price. This embodiment also allows the user to purchase content from multiple content providers, such as purchasing a content package from one content provider and purchasing per-episode content from a second content provider.

The various content packages and other content purchasing options can be displayed to the user in various arrangements. In one example, content packages are arranged based on package price. In another example, content packages are arranged based on the percentage of user content preferences that are satisfied by the package (e.g., a package that provides seven of a user's ten preferences is displayed higher in the listing than a package that provides five of the user's ten preferences).

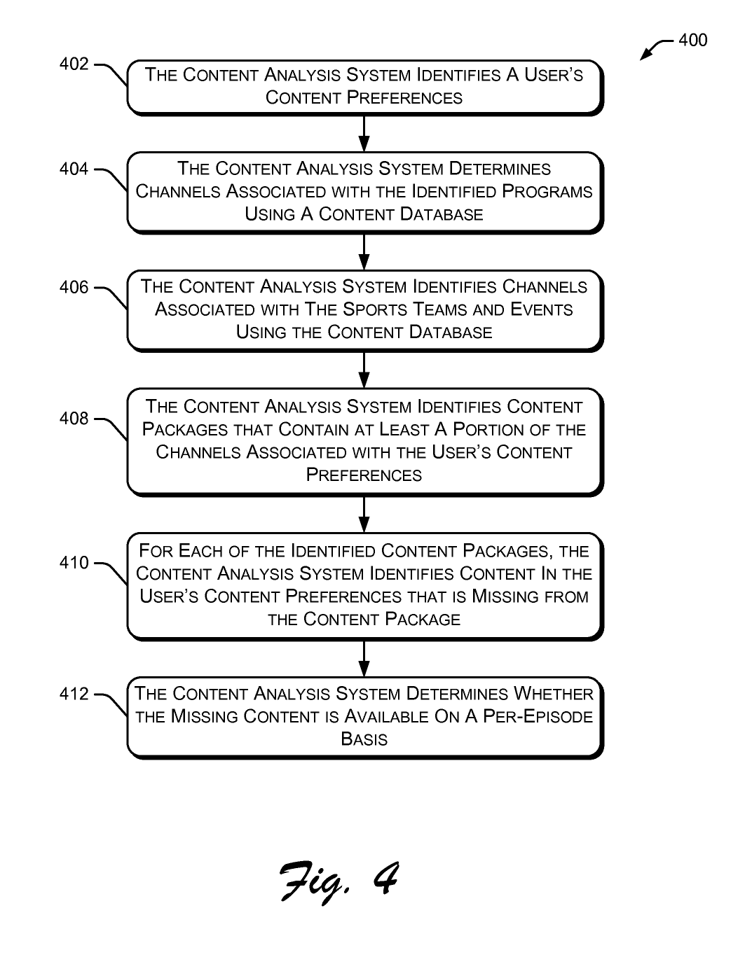

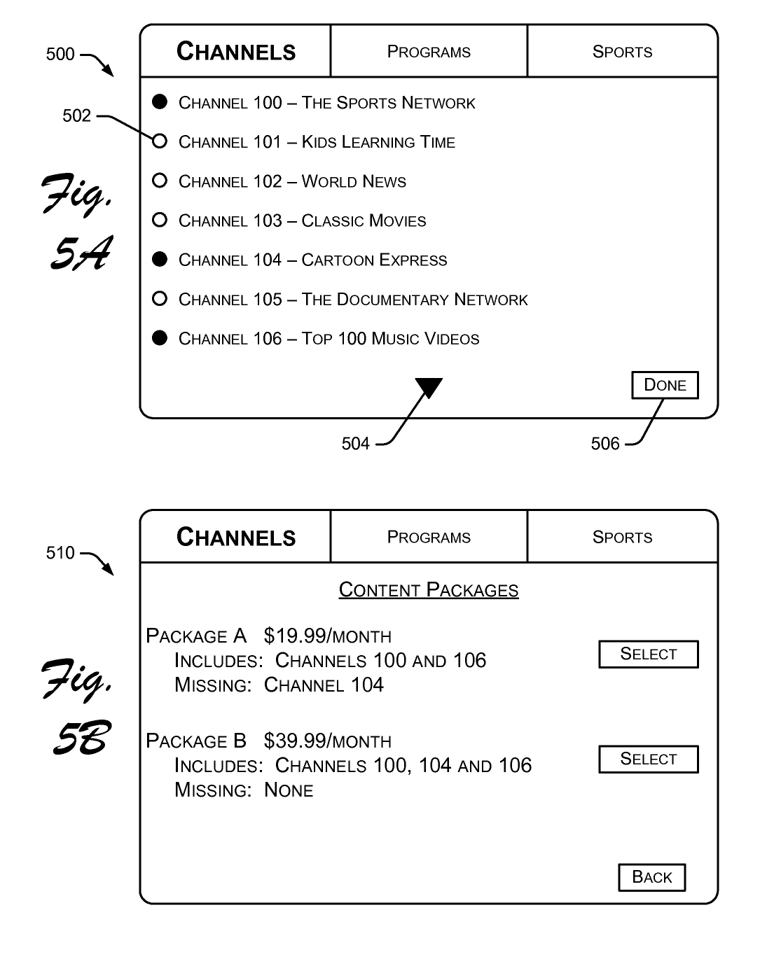

FIG. 5A shows an exemplary display 500 that allows a user to select preferred channels available from one or more content providers, according to one embodiment. In example implementations, display 500 is presented to a user through a Web site associated with a content provider, a content aggregator, or a content analysis system. Display 500 includes three tabs along the top of the display labeled “Channels”, “Programs”, and “Sports”. These tabs represent three general categories of selections available to a user to define their preferred content. In display 500, the “Channels” tab is highlighted indicating that the display allows the user to enter their favorite channels. The three tabs shown in display 500 are provided as an example. Alternate embodiments may include any number of tabs or similar selection mechanisms identifying various categories of content or other user preference options.

Display 500 shows various channels available through one or more content providers. Each channel has an associated selection button 502 that allows the user to indicate that the channel is one of their favorite channels. As shown in display 500, the user has selected “Channel 100”, “Channel 104”, and “Channel 106” as favorite (or preferred) channels. Display 500 also includes a “Done” button 506 that is activated by the user after they have finished selecting their preferred channels. Since the number of available channels typically exceeds the display area of display 500, a scroll button 504 allows the user to scroll down through a list of all available channels. In an alternate embodiment, the available channels can be arranged into a hierarchy that allows the user to easily find their favorite channels. For example, this hierarchy can divide channels into different categories or topics, such as comedy, drama, movies, reality channels, and so forth.

FIG. 5B shows an exemplary display 510 that identifies content packages including at least a portion of the user's preferred channels, according to one embodiment. In this embodiment, display 510 is presented to the user after they activate “Done” button 506 shown in FIG. 5A. Display 510 identifies two content packages (labeled “Package A” and “Package B”) that are appropriate options for the user based on the content preferences identified in display 500. Package A is less expensive than Package B, but only includes two of the user's three preferred channels. Thus, the user can make an informed decision regarding whether to pay the additional cost associated with Package B to obtain the additional channel (i.e., Channel 104). After making a decision regarding the two content packages, the user activates the appropriate “Select” button to purchase the content package. If the user wants to change their content preference selections, they can activate the “Back” button to return to display 500.

Although not shown in FIG. 5B, display 510 may include an identification of the cost differential between different content packages. For example, display 510 may include a statement indicating that Package B costs an additional $20.00 per month to gain access to Channel 104. This cost differential information assists the user in making a selection among multiple content packages.

In alternate embodiments, display 510 includes a “More Information” button associated with each of the content packages. A user can activate the “More Information” button to get details regarding a particular content package, such as a listing of all channels available in the package.

In the example of FIGS. 5A and 5B, the user's content preferences include various identified channels. In other embodiments, the user may select particular channels as well as individual programs, individual sporting events, particular sports teams, and so forth. All of these user selections are combined as the user's content preferences. These multiple selections are used by the content analysis system to identify appropriate content packages for the user. In a particular example, a user may select several favorite channels, several favorite programs, and their two favorite sports teams. As discussed above, the content analysis system then identifies channels associated with the user's favorite programs and favorite sports teams. Based on these identified channels and the channels specifically selected by the user, the content analysis system identifies content packages appropriate for the user. Those content packages are displayed, for example, in the manner shown in display 510.

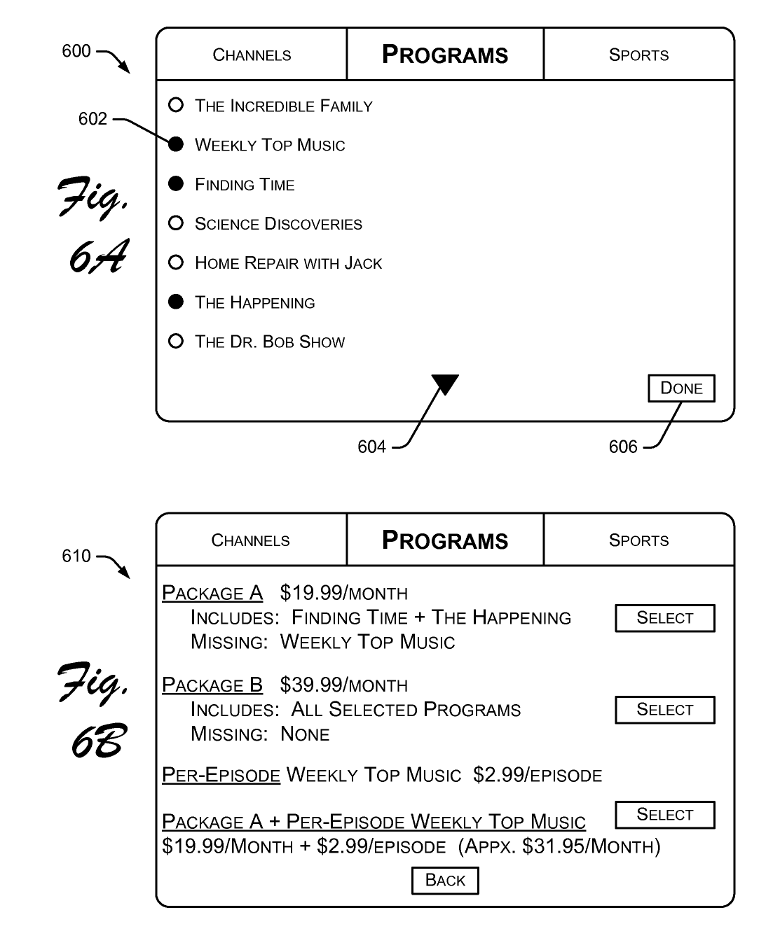

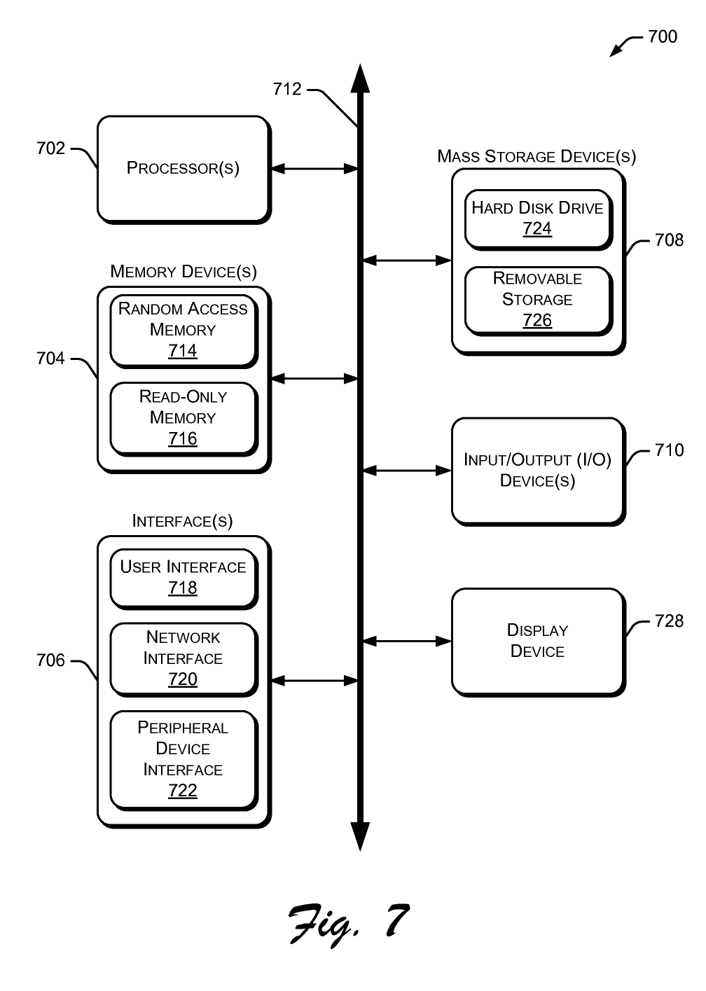

FIG. 6A shows an exemplary display 600 that allows a user to select preferred programs available from one or more content providers, according to one embodiment. Display 600 is similar to display 500 discussed above, but includes listings of programs instead of channels. The user selects their favorite programs using a selection button 602. As shown in display 600, the user has selected three programs: “Weekly Top Music”, “Finding Time”, and “The Happening” as favorite (or preferred) programs. By selecting programs by name, the user does not need to know what channel carries (e.g., broadcasts) a particular program. Instead, the user selects specific programs and the content analysis system determines channels associated with those specific programs.

Display 600 also includes a “Done” button 606 that is activated by the user after they have finished selecting their preferred programs. Since the number of available programs typically exceeds the display area of display 600, a scroll button 604 allows the user to scroll down through a list of all available programs. In an alternate embodiment, the available programs can be arranged into a hierarchy that allows the user to easily find their favorite programs. For example, this hierarchy can divide programs into different categories or topics, such as comedies, dramas, movies, reality programs, and so forth.

FIG. 6B shows an exemplary display 610 that identifies per-episode content as well as content packages including at least a portion of the user's preferred programs, according to one embodiment. In this embodiment, display 610 is presented to the user after they activate “Done” button 606 shown in FIG. 6A. Display 610 identifies two content packages (labeled “Package A” and “Package B”) and per-episode content that are appropriate options for the user based on the program preferences identified in display 600.

As shown in FIG. 6B, Package A is less expensive than Package B, but is missing one of the user's preferred programs (e.g., missing “Weekly Top Music”). Display 610 also indicates that “Weekly Top Music” is available for purchase on a per-episode basis. If the user wants to receive the “Weekly Top Music” program, they can choose Package B (which includes the program) or choose Package A along with the per-episode pricing for the program. Display 610 shows the price differences to the user, allowing them to make an informed decision. In this example, the cost for Package B is $39.99 per month and the cost of Package A along with the per-episode pricing for “Weekly Top Music” is approximately $31.95 per month. The user can choose whether to add the one program for a lower overall monthly cost or purchase the more expensive content package and receive all of the additional content included in that package. The per-episode pricing for “Weekly Top Music” is approximately $31.95 per month, because most months will have four episodes of the program (one episode per week). During a few months, the program will have five episodes. Thus, the cost per month for the per-episode content will vary.

After making a decision regarding the available content purchasing options, the user activates the appropriate “Select” button to purchase the content. If the user wants to change their content preference selections, they can activate the “Back” button to return to display 600.

The arrangement and information displayed in FIGS. 5A, 5B, 6A, and 6B are provided by way of example. Alternate embodiments may display any type of information arranged in any manner. These alternate embodiments may include additional displays for identifying user preferences and displaying content purchasing options.

FIG. 7 is a block diagram showing an exemplary computing device 700, according to one embodiment. Computing device 700 may be used to perform various procedures, such as those discussed herein. Computing device 700 can function as a server, a client, or any other computing entity. Computing device 700 can be any of a wide variety of computing devices, such as a desktop computer, a notebook computer, a server computer, a handheld computer, a tablet computer, and the like. In a particular embodiment, computing device 700 is a content analysis system of the type discussed herein.

Computing device 700 includes one or more processor(s) 702, one or more memory device(s) 704, one or more interface(s) 706, one or more mass storage device(s) 708, one or more Input/Output (I/O) device(s) 710, and a display device 728, all of which are coupled to a bus 712. Processor(s) 702 include one or more processors or controllers that execute instructions stored in memory device(s) 704 and/or mass storage device(s) 708. Processor(s) 702 may also include various types of computer-readable media, such as cache memory.

Memory device(s) 704 include various computer-readable media, such as volatile memory (e.g., random access memory (RAM)) 714 and/or nonvolatile memory (e.g., read-only memory (ROM)) 716. Memory device(s) 704 may also include rewritable ROM, such as Flash memory.

Mass storage device(s) 708 include various computer readable media, such as magnetic tapes, magnetic disks, optical disks, solid state memory (e.g., Flash memory), and so forth. As shown in FIG. 7, a particular mass storage device is a hard disk drive 724. Various drives may also be included in mass storage device(s) 708 to enable reading from and/or writing to the various computer readable media. Mass storage device(s) 708 include removable storage 726 and/or non-removable media.

I/O device(s) 710 include various devices that allow data and/or other information to be input to or retrieved from computing device 700. Example I/O device(s) 710 include cursor control devices, keyboards, keypads, microphones, monitors or other display devices, speakers, printers, network interface cards, modems, lenses, CCDs or other image capture devices, and the like.

Display device 728 includes any type of device capable of displaying information to one or more users of computing device 700. Examples of display device 728 include a monitor, display terminal, video projection device, and the like.

Interface(s) 706 include various interfaces that allow computing device 700 to interact with other systems, devices, or computing environments. Example interface(s) 706 include any number of different network interfaces 720, such as interfaces to local area networks (LANs), wide area networks (WANs), wireless networks, and the Internet. Other interfaces include user interface 718 and peripheral device interface 722.

Bus 712 allows processor(s) 702, memory device(s) 704, interface(s) 706, mass storage device(s) 708, and I/O device(s) 710 to communicate with one another, as well as other devices or components coupled to bus 712. Bus 712 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 700, and are executed by processor(s) 702. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

### Conclusion

Although the systems and methods for identifying content purchasing options have been described in language specific to structural features and/or methodological operations or actions, it is understood that the implementations defined in the appended claims are not necessarily limited to the specific features or actions described. Rather, the specific features and operations of identifying content purchasing options are disclosed as exemplary forms of implementing the claimed subject matter.

1. A processor-implemented method comprising:
receiving user content preferences;
identifying a plurality of content packages associated with a content provider that include at least a portion of the user content preferences;
identifying any user content preferences missing from each of the plurality of content packages; and
generating a listing of content purchasing options appropriate for the user based on the identified content packages and the user content preferences, wherein the listing of content purchasing options includes any user content preferences missing from each of the plurality of content packages.

2. A method as recited in claim 1 wherein the listing of content purchasing options includes pricing information associated with each of the plurality of content packages.

3. A method as recited in claim 1 wherein the listing of content purchasing options includes identification of an incremental cost to satisfy all user content preferences.

4. A method as recited in claim 1 wherein the listing of content purchasing options includes per-episode costs associated with user content preferences missing from at least one content purchasing option.

5. A method as recited in claim 1 wherein the user content preferences include preferred content channels.

6. A method as recited in claim 1 wherein the user content preferences include preferred programs.

7. A method as recited in claim 1 wherein the user content preferences include preferred sports teams.

8. A method as recited in claim 1 wherein the user content preferences include preferred content genres.

9. A method as recited in claim 1, further comprising:
identifying preferred programs in the user content preferences; and
determining a channel associated with each of the preferred programs.

10. A method as recited in claim 1, further comprising communicating the listing of content purchasing options appropriate for the user to a content provider associated with the user.

11. A method as recited in claim 1 wherein the content provider is a satellite-based content provider.

12. A processor-implemented method comprising:
receiving user content preferences;
identifying a first content package associated with a first content provider that includes at least a portion of the user content preferences;
identifying a second content package associated with a second content provider that includes at least a portion of the user content preferences; and
generating a listing of content purchasing options for the user, wherein the listing of content purchasing options includes the first content package and the second content package.

13. A method as recited in claim 12, further comprising:
identifying any missing user content preferences from the first content package; and
identifying any missing user content preferences from the second content package.

14. A method as recited in claim 13 wherein the listing of content purchasing options identifies any user content preferences missing from the first content package and the second content package.

15. A method as recited in claim 13, further comprising determining whether any user content preferences missing from the first content package or the second content package are available for purchase on a per-episode basis.

16. A method as recited in claim 13 wherein the listing of content purchasing options includes per-episode pricing information associated with content preferences missing from the first content package or the second content package.

17. A method as recited in claim 12, further comprising determining a content purchasing option that includes the first content package and at least one episode of content available for purchase on a per-episode basis.

18. A method as recited in claim 12 wherein the user content preferences include at least one of a content channel, a program, a sports team, and a content genre.

19. A content analysis system comprising:
a processor; and
a memory coupled to the processor, the memory comprising processor-executable instructions that, when executed by the processor, perform operations including:
receiving user content preferences;
identifying a plurality of content packages associated with a content provider that include at least a portion of the user content preferences;
identifying any user content preferences missing from each of the plurality of content packages;
determining whether any missing user content preferences are available for purchase on a per-episode basis; and
generating a listing of content purchasing options based on the user content preferences, wherein the listing of content purchasing options includes at least one content package and at least one missing user content preference available for purchase on a per-episode basis.

20. A content analysis system as recited in claim 19 wherein the memory further comprises processor-executable instructions that, when executed by the processor, communicate the listing of content purchasing options to a content provider.
